(19) United States
(12) Patent Application Publication
(10) Pub. No.: US 2012/0307009 A1
(43) Pub. Date: Dec. 6, 2012

(54) METHOD AND APPARATUS FOR GENERATING IMAGE WITH SHALLOW DEPTH OF FIELD

(75) Inventor: Yun-Chin Li, New Taipei City (TW)

(73) Assignee: ALTEK CORPORATION, Hsinchu City (TW)

(21) Appl. No.: 13/228,458

(22) Filed: Sep. 9, 2011

(30) Foreign Application Priority Data
May 31, 2011 (TW) 100119031

(51) Int. Cl. H04N 13/02

(52) U.S. Cl. 348/46; 348/E13.074

(57) ABSTRACT

A method and an apparatus for generating an image with shallow depth of field are provided. The present method includes following steps. A subject is photographed according to a first aperture value, so as to generate a first aperture value image. The subject is photographed according to a second aperture value, so as to generate a second aperture value image, wherein the second aperture value is greater than the first aperture value. The first aperture value image and the second aperture value image are analyzed to generate an image difference value. If the image difference value is greater than a threshold, an image processing is performed on the first aperture value image to obtain the image with shallow depth of field.

### CROSS-REFERENCE TO RELATED APPLICATION

This application claims the priority benefit of Taiwan application serial no. 100119031, filed on May 31, 2011. The entirety of the above-mentioned patent application is hereby incorporated by reference herein and made a part of this specification.

### BACKGROUND OF THE INVENTION

1. Field of the Invention

The invention generally relates to an image processing method and an image processing apparatus, and more particularly, to a method and an apparatus for generating an image with shallow depth of field.

2. Description of Related Art

FIG. 1 is a diagram illustrating how a conventional camera lens focuses on a subject plane. Referring to FIG. 1, when the camera lens 10 focuses on the subject plane 20 and the sharpest image of the subject plane 20 is achieved on the focal plane 30, the distance between the camera lens 10 and the subject plane 20 is a shooting distance Y, and the distance between the camera lens 10 and the focal plane 30 is the focal length y of the camera lens 10. While taking an image by using a camera, a photography technique called shallow depth of field is usually adopted in order to emphasize the subject in the image. Namely, objects within the shooting distance Y are sharply imaged, while objects outside of the shooting distance Y are gradually blurred.

However, the shallow depth of field effect produced by a general camera lens is very limited. In order to obtain an optimal shallow depth of field effect, the same scene should be photographed in a continuous shooting mode at different focal lengths and the sharpest position of each pixel in each image should be respectively determined, so as to determine the relative depth of field of each pixel in the image according to the relationship between focal length and depth of field. This technique requires a very long processing time and takes up a lot of storage space, and therefore is not suitable for being commercialized.

Even though the processing time can be slightly shortened by taking 2 to 3 images on the same scene at different focal lengths (i.e., determining the relationship of relative depth of field between different pixels by using a few images), the images are prone to affection of noises, and accordingly discontinuous or unnatural depth of field may be produced in the processed image.

### SUMMARY OF THE INVENTION

Accordingly, the invention is directed to a method for generating an image with shallow depth of field, wherein the relative depth of field between images taken according to two different aperture values is determined, and the sharpness of image subject is retained and the blur of image background is enhanced according to the relative depth of field.

The invention is directed to an apparatus for generating an image with shallow depth of field, wherein the same scene is photographed according to different aperture values, and the sharpness of image subject is retained and the blur of image background is enhanced through image processing.

The invention provides a method for generating an image with shallow depth of field. The method includes following steps. A subject is photographed according to a first aperture value, so as to generate a first aperture value image. The subject is photographed according to a second aperture value, so as to generate a second aperture value image, wherein the second aperture value is greater than the first aperture value. The first aperture value image and the second aperture value image are analyzed to obtain an image difference value. If the image difference value is greater than a threshold, an image processing is performed on the first aperture value image to generate the image with shallow depth of field.

According to an embodiment of the invention, the step of photographing the subject according to the first aperture value so as to generate the first aperture value image includes focusing on and photographing the subject according to the first aperture value so as to generate the first aperture value image and selecting a sharp area containing the subject in the first aperture value image.

According to an embodiment of the invention, after the step of photographing the subject according to the second aperture value so as to generate the second aperture value image, the method further includes calculating a geometric transformation parameter of the second aperture value image by using the sharp area and performing a geometric transformation on the second aperture value image according to the geometric transformation parameter so as to obtain the transformed second aperture value image.

According to an embodiment of the invention, the step of performing the image processing on the first aperture value image to generate the image with shallow depth of field if the image difference value is greater than the threshold includes following steps. If the image difference value is greater than the threshold, a smoothing process is performed on the first aperture value image and the transformed second aperture value image, so as to obtain a relative depth of field image. A blurring process is performed on the relative depth of field image to generate a blur image. An averaging process is performed on the blur image and the first aperture value image to generate the image with shallow depth of field.

According to an embodiment of the invention, the smoothing process adopts an image interpolation method.

According to an embodiment of the invention, the method for generating the image with shallow depth of field further includes directly outputting the first aperture value image if the image difference value is not greater than the threshold.

The invention also provides an apparatus for generating an image with shallow depth of field. The apparatus includes an image capturing module and a processing module. The image capturing module photographs a subject respectively according to a first aperture value and a second aperture value, so as to respectively generate a first aperture value image and a second aperture value image, wherein the second aperture value is greater than the first aperture value. The processing module is coupled to the image capturing module. The processing module analyzes the first aperture value image and the second aperture value image to obtain an image difference value. When the processing module determines that the image difference value is greater than a threshold, the processing module performs an image processing on the first aperture value image to generate the image with shallow depth of field.

According to an embodiment of the invention, the image capturing module focuses on and photographs the subject according to the first aperture value, so as to generate the first aperture value image.

According to an embodiment of the invention, the processing module selects a sharp area containing the subject in the first aperture value image generated by the image capturing module.

According to an embodiment of the invention, the apparatus for generating the image with shallow depth of field further includes a geometric transformation unit. The geometric transformation unit is coupled to the processing module. The geometric transformation unit calculates a geometric transformation parameter of the second aperture value image by using the sharp area and performs a geometric transformation on the second aperture value image according to the geometric transformation parameter, so as to generate the transformed second aperture value image.

According to an embodiment of the invention, the processing module includes a smoothing processing unit, and a blurring processing unit. If the processing module determines that the image difference value is greater than the threshold, the processing module controls the smoothing processing unit to perform a smoothing process on the first aperture value image and the transformed second aperture value image, so as to obtain a relative depth of field image. The blurring processing unit performs a blurring process on the relative depth of field image to generate a blur image. The processing module performs an averaging process on the blur image and the first aperture value image to generate the image with shallow depth of field.

According to an embodiment of the invention, if the processing module determines that the image difference value is not greater than the threshold, the processing module directly outputs the first aperture value image.

As described above, the invention provides a method and an apparatus for generating an image with shallow depth of field, wherein a same scene is photographed according to different aperture values based on the fact that different aperture values produce different depths of field, and the captured images are compared to determine the relative depth of field between the images. When the image difference value is large enough, the images are composed to retain the sharpness of the image subject and enhance the blur of the image background. When the image difference value is very small, the image captured according to the large aperture value is directly output.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating how a conventional camera lens focuses on a subject plane.

FIG. 2 is a block diagram of an apparatus for generating an image with shallow depth of field according to an embodiment of the invention.

FIG. 3 is a flowchart of a method for generating an image with shallow depth of field according to an embodiment of the invention.

FIG. 4 is a block diagram of an apparatus for generating an image with shallow depth of field according to another embodiment of the invention.

FIG. 5 is a flowchart of a method for generating an image with shallow depth of field according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention provides a method for composing an image with shallow depth of field according to the relationship between depth of field and aperture value. A subject is first focused on and photographed by using a large aperture. Then, a sharp area is roughly defined in the captured image. Next, a second image is captured by using a smaller aperture. The two images are analyzed, and an image difference value between the two images is served as the relative depth of field between the subject area and the background area. Besides, whether an image with shallow depth of field is composed is determined according to the image difference value. Below, embodiments of the invention will be described with reference to accompanying drawings.

FIG. 2 is a block diagram of an apparatus for generating an image with shallow depth of field according to an embodiment of the invention. Referring to FIG. 2, the apparatus 200 for generating images with shallow depth of field in the present embodiment may be a digital camera, a video camera, or a smart phone with a camera function, etc. The apparatus 200 includes an image capturing module 210 and a processing module 220, which will be respectively description below.

The image capturing module 210 includes a lens, a photo sensor, and an aperture. The lens may be a standard lens, a wide-angle lens, or a zoom lens. The photo sensor may be a charge coupled device (CCD), a complementary metal-oxide semiconductor (CMOS), or another device. However, the types of the lens and the photo sensor are not limited herein.

The aperture refers to a group of movable diaphragm blades in the lens. The amount of light entering the image capturing module 210 during a specific period can be controlled by adjusting the diameter of the opening formed by the diaphragm blades. The opening is enlarged or reduced along with the adjustment of the aperture value (also referred to as an f value by those having ordinary knowledge in the art) on the lens. The most commonly used f values include f1.4, f2, 12.8, f4, f5.6, f8, 111, f16, 122, and f32. It should be noted that the smaller the f value is, the larger the aperture opening is and the more light is allowed to enter, and the larger the f value is, the smaller the aperture opening is and accordingly the less light is allowed to enter. Accordingly, a “large aperture” mentioned in the present embodiment refers to an aperture value with a smaller f value. The image capturing module 210 in the present embodiment photographs a same scene by using two different aperture values, so as to generate a first aperture value image and a second aperture value image.

The processing module 220 may be a central processing unit (CPU), a programmable microprocessor, a digital signal processor (DSP), a programmable controller, an application specific integrated circuits (ASIC), a programmable logic device (PLD), or any other similar device. The processing module 220 is coupled to the image capturing module 210 and configured to analyze and process the first aperture value image and the second aperture value image received from the image capturing module 210, so as to generate an image with shallow depth of field.

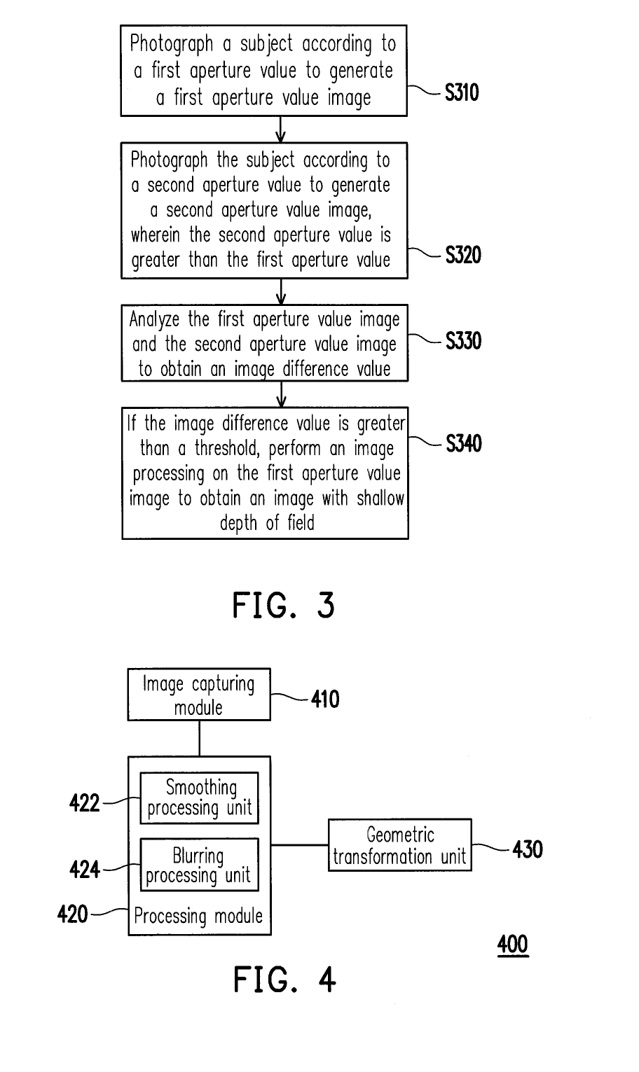

FIG. 3 is a flowchart of a method for generating an image with shallow depth of field according to an embodiment of the invention. Referring to FIG. 3, the method in the present embodiment is suitable for the apparatus 200 illustrated in FIG. 2. Below, the method for generating an image with shallow depth of field provided by the present embodiment will be described in detail with reference to various components of the apparatus illustrated in FIG. 2.

First, in step S310, the image capturing module 210 focuses on and photographs a subject according to a first aperture value, so as to generate a first aperture value image. Then, in step S320, the image capturing module 210 photographs the subject according to a second aperture value without altering any other condition (for example, the focal length, the shutter, or the shooting distance), so as to generate a second aperture value image. Herein the second aperture value is greater than the first aperture value. Namely, the amount of incident light corresponding to the first aperture value image is greater than that corresponding to the second aperture value. Thus, under the same conditions, different images are captured with different apertures. A larger aperture (i.e., a smaller f value) results in a larger sharp area and a blurrier background in the image. Accordingly, in an image captured with a larger aperture, the subject is more vivid and emphasized.

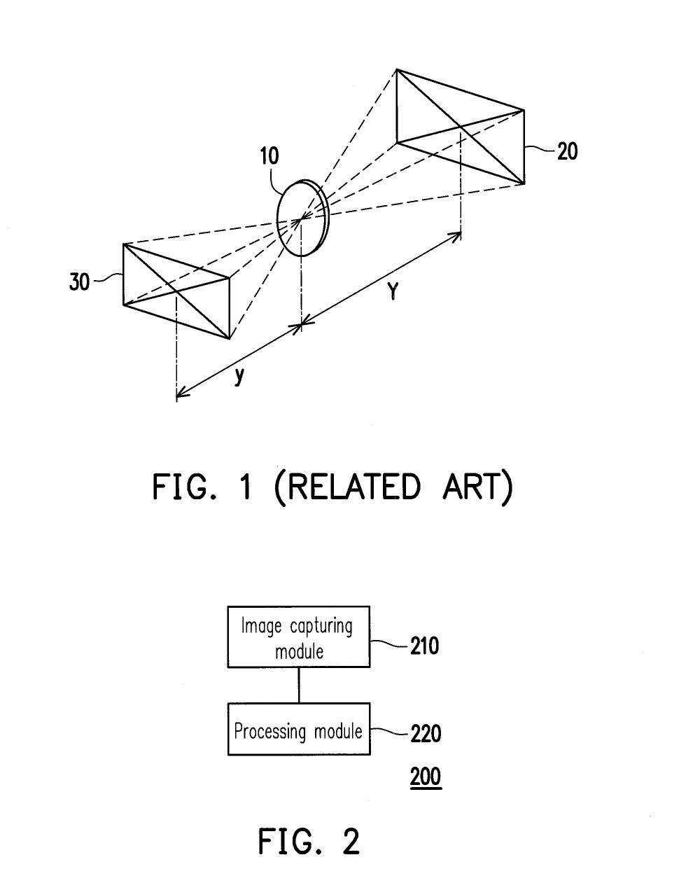

To be specific, when an subject is focused on and photographed by using a large aperture, objects close to the subject plane (for example, the subject plane 20 as shown in FIG. 1) are sharp. If the same subject is photographed by using a smaller aperture without altering any other condition, besides the objects close to the subject plane, objects located farther away from the subject plane are also sharp. Thereby, near and far objects in an image can be determined by comparing two images captured according to different aperture values.

Next, in step S330, the processing module 220 analyzes the first and the second aperture value image based on the concept described above, so as to obtain an image difference value. To be specific, the processing module 220 calculates the difference of grayscale value at corresponding pixels in the first and the second aperture value image and identifies the subject area and the background area through an image edge detection algorithm. If the image difference value is small, none of the objects in the entire image is very far from the focal plane on which the subject is located, and the images captured according to two different aperture values are both sharp. If the image difference value is large, each object in the entire image is far from the focal plane on which the subject is located.

Thus, in step S340, if the processing module 220 determines that the image difference value is greater than a threshold, the processing module 220 performs an image processing on the first aperture value image to obtain the image with shallow depth of field. Herein the threshold may be automatically set by the processing module 220 according to the current shooting mode or set by a user according to the shooting environment. However, the value of the threshold is not limited herein. The image processing is to enhance the blur of the background area (objects farther away from the focal plane on which the subject is located), so as to emphasize the subject and make the subject more vivid.

It should be noted that the proportion between the first aperture value and the second aperture value is related to the characteristics of the lens and the shooting distance (for example, the shooting distance Y in FIG. 1). Thus, the proportion between the first aperture value and the second aperture value should be adjusted in advance according to the characteristics of the lens in the apparatus 200 and different shooting distances. Subsequently, the first aperture value and the second aperture value are appropriately adjusted according to the distance between the lens and the subject when the subject is actually photographed. Thus, the first aperture value and the second aperture value are not fixed and can be adjusted by a user according to the actual shooting situation.

The invention will be further explained with reference to another embodiment. FIG. 4 is a block diagram of an apparatus for generating an image with shallow depth of field according to another embodiment of the invention. Referring to FIG. 4, the apparatus 400 for generating images with shallow depth of field in the present embodiment includes an image capturing module 410, a processing module 420, and a geometric transformation unit 430. The apparatus 400 illustrated in FIG. 4 is similar to the apparatus 200 illustrated in FIG. 2, and only the differences between the two will be explained below.

The processing module 420 includes a smoothing processing unit 422 and a blurring processing unit 424. The smoothing processing unit 422 performs a smoothing process on two images by adopting an image interpolation method. The blurring processing unit 424 blurs an image by using a spatial filter, a linear filter, a non-linear filter, or a blur filter, etc. The geometric transformation unit 430 is coupled to the processing module 420. The geometric transformation unit 430 performs motion correction by using an affine transformation matrix, so as to locate the starting pixels in two different images at the same position.

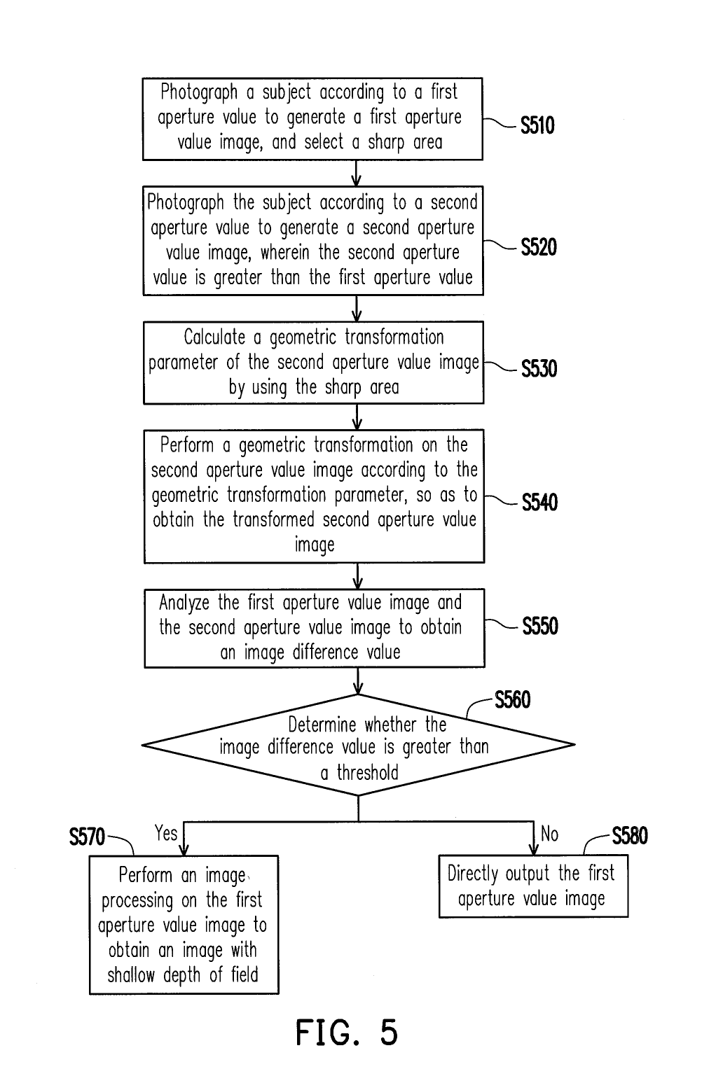

FIG. 5 is a flowchart of a method for generating an image with shallow depth of field according to another embodiment of the invention. Please refer to both FIG. 4 and FIG. 5 regarding following description.

The image capturing module 410 photographs a subject according to a first aperture value, so as to generate a first aperture value image. The processing module 420 then selects a sharp area containing the subject (i.e., a focal area on the subject plane, wherein the part of the image within the focal area is sharp) in the first aperture value image (step S510). Next, the image capturing module 410 photographs the subject according to a second aperture value, so as to generate a second aperture value image, wherein the second aperture value is greater than the first aperture value (step S520).

The geometric transformation unit 430 calculates a geometric transformation parameter regarding the sharp area by using an affine transformation matrix (step S530) and performs a geometric transformation on the second aperture value image according to the geometric transformation parameter, so as to make the starting pixel of the sharp area in the transformed second aperture value image to be at the same position as the starting pixel of the sharp area in the first aperture value image (step S540). The processing module 420 analyzes the first aperture value image and the transformed second aperture value image to obtain an image difference value (step S550). After that, the processing module 420 determines whether the image difference value is greater than a threshold (step S560).

If the image difference value is greater than the threshold, the processing module 420 performs an image processing on the first aperture value image to obtain an image with shallow depth of field (the blur of the background is enhanced) (step S570). For example, the processing module 420 controls the smoothing processing unit 422 to perform interpolation on the first aperture value image and the transformed second aperture value image, so as to obtain a relative depth of field image. To be specific, because the image difference value is large enough (i.e., the first aperture value image has a deeper depth of field and the second aperture value image has a shallower depth of field), a relative depth of field image with continuous depth of field is generated through the smoothing process of interpolation. Next, the blurring processing unit 424 performs a blurring process on the relative depth of field image to generate a blur image, wherein the blurring level can be determined in advance by a user. Finally, the processing module 420 performs an averaging process (for example, a weighted averaging process) on pixels in the blur image and the first aperture value image. Accordingly, an image with shallow depth of field (i.e., the sharpness of the subject area is retained while the background area is further blurred) is generated.

However, if the processing module 420 determines that the image difference value is not greater than the threshold in step S560, the background area and objects other than the subject are all close to the subject plane. Namely, the two images captured respectively according to the first aperture value and the second aperture value are both sharp images, and it is impossible to compose an image with shallow depth of field and enhanced blur background. Thus, the first aperture value image is directly output (step S580). In an embodiment, when the processing module 420 determines that the image difference value is not greater than the threshold, a prompt image is displayed on the screen (not shown) of the apparatus 400 to notify the user that the current scene is not suitable for composing an image with shallow depth of field, so that the user can find another scene with deep depth of field. Accordingly, calculation in the apparatus 400 for generating images with shallow depth of field can be simplified and the processing time thereof can be shortened. In another embodiment, if the user captures images by using the largest aperture and the smallest aperture that can be provided by the image capturing module 410 and the image difference value between the two images is not greater than the threshold (i.e., the relative depth of field cannot be determined), the images can be captured again after changing the focal length of the lens, so as to generate two images with a large image difference value. However, because the focal length of the lens is directly related to the shooting distance, the focal length of the lens should be adjusted according to the actual shooting situation in order to capture two images with an image difference value greater than the threshold.

In summary, the invention provides a method and an apparatus for generating an image with shallow depth of field. According to the invention, an image with shallow depth of field can be obtained by simply using two images captured with different apertures. Unlike in a high-grade camera with an expensive zoom lens in which a series of continuous shootings have to be performed to calculate and generate an image with shallow depth of field, the calculation in the invention is simple and can be achieved by any commercial camera. Moreover, in the method and apparatus provided by the invention, if the image difference value between two images is small and accordingly no image with shallow depth of field can be composed, the user is notified in advance to photograph another suitable scene, so that the processing time is shortened.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for generating an image with shallow depth of field, comprising:
photographing a subject according to a first aperture value, so as to generate a first aperture value image;
photographing the subject according to a second aperture value, so as to generate a second aperture value image, wherein the second aperture value is greater than the first aperture value;
analyzing the first aperture value image and the second aperture value image to obtain an image difference value; and
when the image difference value is greater than a threshold, performing an image processing on the first aperture value image to generate the image with shallow depth of field.

2. The method according to claim 1, wherein the step of photographing the subject according to the first aperture value, so as to generate the first aperture value image comprises:
focusing on and photographing the subject according to the first aperture value, so as to generate the first aperture value image; and
selecting a sharp area containing the subject in the first aperture value image.

3. The method according to claim 2, wherein after the step of photographing the subject according to the second aperture value, so as to generate the second aperture value image, the method further comprises:
calculating a geometric transformation parameter of the second aperture value image by using the sharp area; and
performing a geometric transformation on the second aperture value image according to the geometric transformation parameter, so as to generate the transformed second aperture value image.

4. The method according to claim 3, wherein the step of performing the image processing on the first aperture value image to generate the image with shallow depth of field when the image difference value is greater than the threshold comprises:
when the image difference value is greater than the threshold, performing a smoothing process on the first aperture value image and the transformed second aperture value image, so as to obtain a relative depth of field image;
performing a blurring process on the relative depth of field image to generate a blur image; and
performing an averaging process on the blur image and the first aperture value image to generate the image with shallow depth of field.

5. The method according to claim 4, wherein the smoothing process adopts an image interpolation method.

6. The method according to claim 1 further comprising:
when the image difference value is not greater than the threshold, directly outputting the first aperture value image.

7. An apparatus for generating an image with shallow depth of field, comprising:
an image capturing module, photographing an subject respectively according to a first aperture value and a second aperture value, so as to respectively generate a first aperture value image and a second aperture value image, wherein the second aperture value is greater than the first aperture value; and
a processing module, coupled to the image capturing module, wherein the processing module analyzes the first aperture value image and the second aperture value image to obtain an image difference value, and when the processing module determines that the image difference value is greater than a threshold, the processing module performs an image processing on the first aperture value image to generate the image with shallow depth of field.

8. The apparatus according to claim 7, wherein the image capturing module focuses on and photographs the subject according to the first aperture value, so as to generate the first aperture value image.

9. The apparatus according to claim 8, wherein
the processing module selects a sharp area containing the subject in the first aperture value image generated by the image capturing module.

10. The apparatus according to claim 9 further comprising:
a geometric transformation unit, coupled to the processing module, wherein the geometric transformation unit calculates a geometric transformation parameter of the second aperture value image by using the sharp area and performs a geometric transformation on the second aperture value image according to the geometric transformation parameter, so as to generate the transformed second aperture value image.

11. The apparatus according to claim 10, wherein the processing module comprises:
a smoothing processing unit, wherein when the processing module determines that the image difference value is greater than the threshold, the processing module controls the smoothing processing unit to perform a smoothing process on the first aperture value image and the transformed second aperture value image, so as to obtain a relative depth of field image; and
a blurring processing unit, performing a blurring process on the relative depth of field image to generate a blur image,
wherein the processing module performs an averaging process on the blur image and the first aperture value image to generate the image with shallow depth of field.

12. The apparatus according to claim 7, wherein
when the processing module determines that the image difference valus is not greater than the threshold, the processing module directly outputs the first aperture value image.
